(19) United States
(12) Patent Application Publication
(10) Pub. No.: US 2023/0106027 A1
(43) Pub. Date: Apr. 6, 2023

(54) Outlier Incident Detection Using Event Templates

(71) Applicant: PagerDuty, Inc., San Francisco, CA (US)

(72) Inventors: Nigel Antony Knott, Toronto (CA); Vijay Shankar Venkataraman, Toronto (CA); Laura Ann Zuchlewski, San Francisco, CA (US)

(21) Appl. No.: 17/487,374

(22) Filed: Sep. 28, 2021

(51) Int. Cl. G06Q 10/10; G06N 20/00; G06F 9/54

(52) U.S. Cl. CPC G06Q 10/1097; G06N 20/00; G06F 9/542

(57) ABSTRACT

An incident that requires a resolution responsive to an event detected in a managed information technology environment is triggered. A masked title is obtained from a title of the incident. Using the masked title, a title template is obtained for the incident. Using the title template, an incident type is obtained for the incident, where the incident type is selected from a set that includes a rare type, a novel type, and a frequent type. Responsive to determining that the incident is of the rare type or the novel type, an output of the incident is prioritized so as to focus an attention of a responder on the incident; and, responsive to determining that the incident is of the frequent type, a runbook of tasks associated with the title template is automatically executed.

### TECHNICAL FIELD

This disclosure relates generally to computer operations and more particularly, but not exclusively to providing real-time management of information technology operations.

### BACKGROUND

Information technology (IT) systems are increasingly becoming complex, multivariate, and in some cases non-intuitive systems with varying degrees of nonlinearity. These complex IT systems may be difficult to model or accurately understand. Various monitoring systems may be arrayed to provide events, alerts, notifications, or the like, in an effort to provide visibility into operational metrics, failures, and/or correctness. However, the sheer size and complexity of these IT systems may result in a flooding of disparate event messages from disparate monitoring/reporting services.

With the increased complexity of distributed computing systems existing event reporting and/or management may not, for example, have the capability to effectively process events in complex and noisy systems. At enterprise scale, IT systems may have millions of components resulting in a complex inter-related set of monitoring systems that report millions of events from disparate subsystems. Manual techniques and pre-programmed rules are labor and computing intensive and expensive, especially in the context of large, centralized IT Operations with very complex systems distributed across large numbers of components. Further, these manual techniques may limit the ability of systems to scale and evolve for future advances in IT systems capabilities. 2

### SUMMARY

Disclosed herein are implementations of a outlier detection using templates.

A first aspect is A method that includes triggering an incident that requires a resolution responsive to an event detected in a managed information technology environment; obtaining a masked title from a title of the incident; obtaining, using the masked title, a title template for the incident; obtaining, using the title template, an incident type for the incident, where the incident type is selected from a set that includes a rare type, a novel type, and a frequent type; responsive to determining that the incident is of the rare type or the novel type, prioritizing an output of the incident so as to focus an attention of a responder on the incident; and, responsive to determining that the incident is of the frequent type, automatically executing a runbook of tasks associated with the title template.

A second aspect is an apparatus that includes a memory and a processor. The processor is configured to execute instructions stored in the memory to obtain a title for a resolvable object; obtain, using the title, a title template for the resolvable object; obtain, using the title template, a type for the resolvable object, where the type is selected from a set that includes a rare type and a frequent type; and, responsive to determining that the resolvable object is of the frequent type, execute a runbook associated with the frequent type.

A third aspect is a method that includes identifying, in a set of templates, a template matching a title of a resolvable object, where at least some of the templates include respective constant parts and respective parameter parts; obtaining a type of the resolvable object using the template and historical resolvable object data; and outputting the type in association with the resolvable object.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows components of one embodiment of a computing environment for event management.

FIG. 2 shows one embodiment of a client computer.

FIG. 3 shows one embodiment of a network computer that may at least partially implement one of the various embodiments.

FIG. 4 illustrates a logical architecture of a system for outlier detection using templates.

FIG. 5 is a block diagram of an example illustrating the operations of a classifier.

FIG. 6 illustrates examples of templates.

FIG. 7A illustrates plots of results of algorithms that generate optimal and sub-optimal templates.

FIG. 7B illustrates graphs of template similarities of algorithms that generate optimal and sub-optimal templates.

FIG. 8 is a flowchart of an example of a technique for incident type detection using templates.

FIG. 9 is a flowchart of an example of a technique for resolvable object type detection using templates.

FIG. 10 illustrates examples of partial displays of resolvable objects.

### DETAILED DESCRIPTION

An event management bus (EMB) is a computer system that may be arranged to monitor, manage, or compare the operations of one or more organizations. The EMB may be arranged to accept various events that indicate conditions occurring in the one or more organizations. The EMB may be arranged to manage several separate organizations at the same time. Briefly, an event can simply be an indication of a state of change to an information technology service of an organization. An event can be or describe a fact at a moment in time that may consist of a single or a group of correlated conditions that have been monitored and classified into an actionable state. As such, a monitoring tool of an organization may detect a condition in the IT environment (e.g. such as the computing devices, network devices, software applications, etc.) of the organization and transmit a corresponding event to the EMB. Depending on the level of impact (e.g., degradation of a service), if any, to one or more constituents of a managed organization, an event may trigger (e.g., may be, may be classified as, may be converted into) an incident.

Non-limiting examples of events may include that a monitored operating system process is not running, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 503 error code (indicating that web server is not ready to handle requests), that a customer relationship management (CRM) system is down (e.g., unavailable) such as because it is not responding to ping requests, and so on.

At a high level, an event may be received at an ingestion engine of the EMB, accepted by the ingestion engine and queued for processing, and then processed. Processing an event can include triggering (e.g., creating, generating, instantiating, etc.) a corresponding alert and a corresponding incident in the EMB, sending a notification of the incident to a responder (i.e., a person, a group of persons, etc.), and/or triggering a response (e.g., a resolution) to the incident. The incident associated with the alert may or may be used to notify the responder who can acknowledge (e.g., assume responsibility for resolving) and resolve the incident. An acknowledged incident is an incident that is being worked on but is not yet resolved. The user that acknowledges an incident claims ownership of the incident, which may halt any established escalation processes. As such, notifications provide a way for responders to acknowledge that they are working on an incident or that the incident has been resolved. The responder may indicate that the responder resolved the incident using an interface (e.g., a graphical user interface) of the EMB.

On any given day, a plethora of alerts and incidents may be triggered and notifications sent to responders due to received events. Additionally, a single event in a managed environment may have a cascading effect such that the event may cause other events, which in turn may cause other events, and so on, therewith resulting in an alert or incident storm (e.g., a significantly high number of alerts or incidents received within a short period of time and having the same or related causes or symptoms). Furthermore, more and more monitoring tools may be deployed in the IT environment of an organization, which in turn may transmit additional event types to the EMB and may compound the number of alerts or incidents triggered and notifications sent.

Given such a high number of triggered alerts or incidents, or received notifications, existing computer systems may not be able to adequately or efficiently categorize, summarize, or utilize the higher volume of data and responders may not be able to effectively resolve (e.g., manage, prioritize, etc.) incidents. For example, existing systems may not recognize or effectively facilitate the recognition of the full extent of event patterns and the frequency at which events are received becomes increasingly difficult for responders to discern. As such, such systems may not be able to, or be able to be used to effectively, determine which incidents require more time to resolve, which incidents may be associated with sufficient institutional knowledge that can be used to expedite incident resolution or present opportunities for automating responses, or which incidents to currently ignore. To reiterate, existing systems have deficiencies when processing, analyzing, and presenting information regarding voluminous alerts, incidents, or notifications and thus, it may not be possible for responders to effectively respond to and resolve issues that cause such alerts, incidents and notifications.

Ineffective and/or untimely resolution of incidents can lead to reduced uptime(s), and thus degraded performance, of computing resources. The possibility of degraded performance may also include substantially increased investment (such as to compensate for the degradation) in processing, memory, and storage resources and may also result in increased energy expenditures (needed to operate those increased processing, memory, and storage resources, and for the network transmission of the database commands) and associated emissions that may result from the generation of that energy.

Implementations according to this disclosure facilitate incident resolution in an EMB so that mean-time-to-resolution (MTTR) of incidents can be minimized therewith maximizing uptime(s) of components, systems, devices, services, etc. of an IT environment of a managed organization.

The disclosure herein uses the term “resolvable object.” A resolvable object can be a construct of the EMB with which a reason for and/or a cause of can be determined, and/or a resolution thereto can be marked. No particular semantics are intended to be attached to the term “object” in “resolvable object.” A resolvable object can be any entity of the EMB that may be associated with a class (such as in the case of object-oriented programming), a data structure that may include metadata (e.g. attributes, fields, etc.), a set of data elements (elementary or otherwise) that can collectively represent a resolvable object, and so on. A resolvable object can be an object of (e.g., triggered in, created in, received by, etc.) the EMB, or an object related thereto, about which a notification may be transmitted to a responder, with respect to which a responder may directly or indirectly enter an acknowledgement, with respect to which a responder may directly or indirectly enter or indicate a resolution, based on which a responder may perform an action, or a combination thereof. Examples of resolvable objects can include events, incidents, and alerts.

Some resolvable objects (referred to herein as rare or novel resolvable objects, resolvable objects of a rare type or a novel type, or resolvable objects classified as rare or novel) can be triggered from rarely occurring events or from newly discovered events, respectively. Resolvable objects of the rare or the novel types may require the focused attention of responders and may require longer times to resolve as no institutional knowledge (or accumulated expertise) may be associated with such rare or novel resolvable objects. As can be appreciated, less (if any) institutional knowledge may be associated with novel resolvable objects than with rare resolvable objects.

Some other resolvable objects (referred to herein as frequent resolvable objects, objects of the frequent type, or resolvable objects classified as frequent) may be associated with institutional knowledge that may be used (e.g., leveraged, etc.) to quickly resolve such frequent resolvable objects, to identify experts in resolving such resolvable objects, to automate remediation of such resolvable objects, or to institute preventative maintenance measures to prevent future occurrences of such resolvable objects, therewith decreasing the frequent impact(s) of such resolvable objects and reducing noise that responders witness. Automating remediation of a certain type of frequent resolvable objects can include associating a runbook of tasks that can be triggered in response to receiving a resolvable object of the certain type.

Using templates (e.g., alert templates, incident templates, or event templates), resolvable objects can be identified (e.g., classified, etc.) as being of the rare type, the novel type, the frequent type, or some other type. A resolvable object (e.g. an incident or an alert) can be identified as matching a template based on metadata (e.g., a title, a group of attributes, etc.) of the resolvable object. As further described below, a template can be a set of tokens where some of the tokens are constant parts and other tokens are variable (or placeholder) parts.

Given a resolvable object (such as in response to an incident being triggered), a template associated with the resolvable object can be identified. The template can be used to identify, such as in a lookback time range, a number of times the same template occurred in the given lookback period before the resolvable object occurred (e.g., before the incident or alert was triggered). The number of occurrences can be used to classify the resolvable object as being of the rare type, the novel type, or the frequent type.

By classifying resolvable objects (such as as rare, novel, or frequent), implementations according to this disclosure can facilitate or enable the reduction of MTTR at least because, using the classifications, the system can operate to focus tasks, analysis and presentation of data with respect to new or rare resolvable objects (e.g., incidents, events, alerts) that may be more challenging to resolve, which may result in greater effectiveness in addressing frequent resolvable objects (such as by identifying incident types for automated remediation, planning performance improvements, or scheduling or performing preventative maintenance tasks to address recurring events), adjusting monitoring configurations associated with such frequent resolvable objects, or a combination thereof. Adjusting the monitoring configurations can include, for example, stopping the transmission to the EMB, or the ingestion by the EMB, of events associated with frequent resolvable objects, decreasing the priorities of frequent resolvable objects, or any other configuration adjustments.

While the teachings herein are described with respect to classifying a resolvable object (an event, an alert, an incident) as rare, novel, or frequent using a title of the resolvable object, the disclosure is not so limited. The teachings herein can be used to classify any datum into one or more categories (e.g., classes) by matching one or more attributes associated with (e.g., of, related to, obtained for, derived from related entities to, etc.) the datum to a template and using historical data to determine a number of occurrences of the template in the historical data wherein at least some of the historical data are associated with respective templates.

The term “organization” or “managed organization” as used herein refers to a business, a company, an association, an enterprise, a confederation, or the like.

The term “event,” as used herein, can refer to one or more outcomes, conditions, or occurrences that may be detected (e.g., observed, identified, noticed, monitored, etc.) by an event management bus. An event management bus (which can also be referred to as an event ingestion and processing system) may be configured to monitor various types of events depending on needs of an industry and/or technology area. For example, information technology services may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof.

Events may be provided to the event management bus using one or more messages, emails, telephone calls, library function calls, application programming interface (API) calls, including, any signals provided to an event management bus indicating that an event has occurred. One or more third party and/or external systems may be configured to generate event messages that are provided to the event management bus.

The term “responder” as used herein can refer to a person or entity, represented or identified by persons, that may be responsible for responding to an event associated with a monitored application or service. A responder is responsible for responding to one or more notification events. For example, responders may be members of an information technology (IT) team providing support to employees of a company. Responders may be notified if an event or incident they are responsible for handling at that time is encountered. In some embodiments, a scheduler application may be arranged to associate one or more responders with times that they are responsible for handling particular events (e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a user or automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, services that may be impacted by a pending incident, may be added to the incident response associated with the incident. Likewise, resources responsible for supporting or maintaining the services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, in at least one of the various embodiments, notification messages may be provided to the one or more responsible resources using SMS texts, MMS texts, email, Instant Messages, mobile device push notifications, HTTP requests, voice calls (telephone calls, Voice Over IP calls (VOIP), or the like), library function calls, API calls, URLs, audio alerts, haptic alerts, other signals, or the like, or combination thereof.

The term “team” or “group” as used herein refers to one or more responders that may be jointly responsible for maintaining or supporting one or more services or system for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

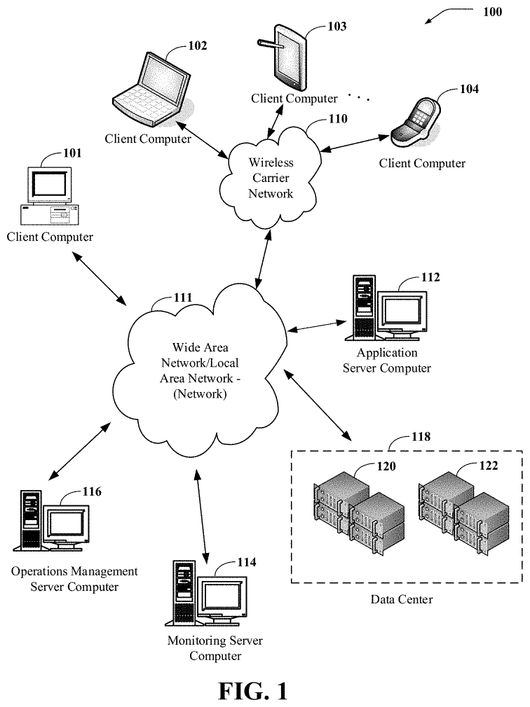

FIG. 1 shows components of one embodiment of a computing environment 100 for event management. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IOT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one embodiment, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. In essence, the wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. In essence, the network 111 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

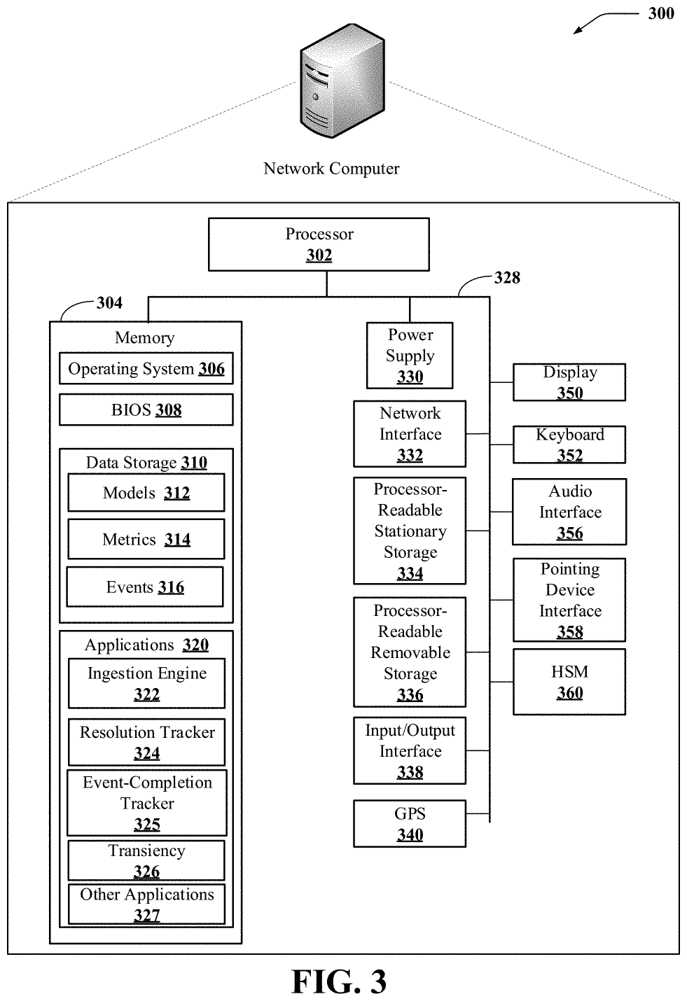

The operations management server computer 116 may include virtually any network computer usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various embodiments, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. In at least one of the various embodiments, the data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may be vary depending on the demands of individual users, cloud network arrangement, operational loads, performance considerations, application needs, operational policy, or the like. In at least one of the various embodiments, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

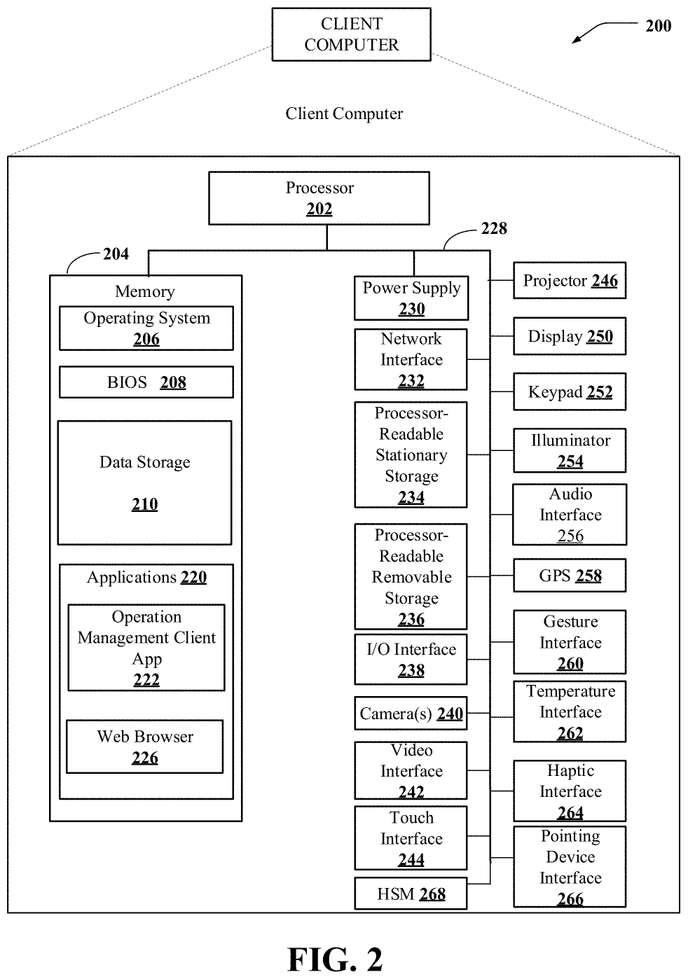

FIG. 2 shows one embodiment of a client computer 200. The client computer 200 may include more or less components than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measuring or maintaining an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open air gesture interface 260 may sense physical gestures of a user of the client computer 200, for example, by using single or stereo video cameras, radar, a gyroscopic sensor inside a computer held or worn by the user, or the like. The camera 240 may be used to track physical eye movements of a user of the client computer 200.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various embodiments, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include more or less components than those shown in FIG. 3. The network computer 300 may represent, for example, one embodiment of at least one EMB, such as the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may include an ingestion engine 322, a resolution tracker engine 324, a classifier 325, a pre-processing engine 326, other applications 327. In at least one of the various embodiments, one or more of the applications may be implemented as modules or components of another application. Further, in at least one of the various embodiments, applications may be implemented as operating system extensions, modules, plugins, or the like.

Furthermore, in at least one of the various embodiments, the ingestion engine 322, the resolution tracker engine 324, the classifier 325, the pre-processing engine 326, the other applications 327, or the like, may be operative in a cloud-based computing environment. In at least one of the various embodiments, these applications, and others, that comprise the management platform may be executing within virtual machines or virtual servers that may be managed in a cloud-based based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines or virtual servers dedicated to the ingestion engine 322, the resolution tracker engine 324, the classifier 325, the pre-processing engine 326, the other applications 327, may be provisioned and de-commissioned automatically.

In at least one of the various embodiments, the applications may be arranged to employ geo-location information to select one or more localization features, such as, time zones, languages, currencies, calendar formatting, or the like. Localization features may be used in user-interfaces and well as internal processes or databases. Further, in some embodiments, localization features may include information regarding culturally significant events or customs (e.g., local holidays, political events, or the like) In at least one of the various embodiments, geo-location information used for selecting localization information may be provided by the GPS transceiver 340. Also, in some embodiments, geolocation information may include information providing using one or more geolocation protocol over the networks, such as, the wireless network 108 or the network 111.

Also, in at least one of the various embodiments, the ingestion engine 322, the resolution tracker engine 324, the classifier 325, the pre-processing engine 326, the other applications 327, or the like, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

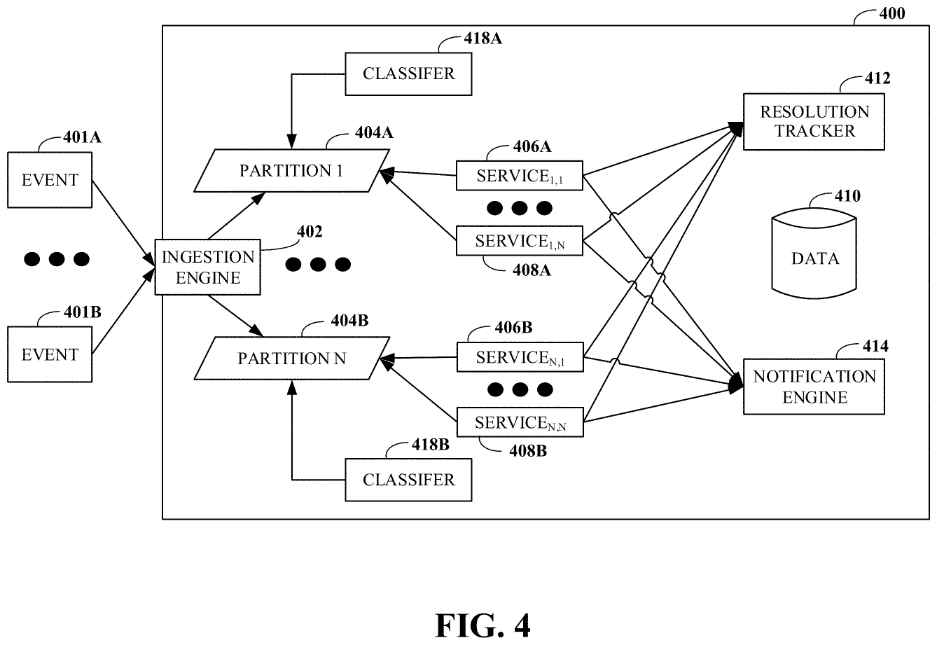

FIG. 4 illustrates a logical architecture of a system 400 for outlier detection using templates. The system 400 can be an EMB and can be used to obtain classifications (e.g., types) for resolvable objects. As mentioned, a resolvable object can be an incident, an alert, an event, or some other object of or created in the system 400.

In an example, a classification may be obtained for and/or associated with a resolvable object based on data associated with the resolvable object itself. For example, metadata (e.g., an attribute or a combination of attributes) of the resolvable object can be used to obtain a type for the resolvable object. For example, a title of the resolvable object can be used to obtain the type. In an example, the classification may be obtained for and/or associated with a resolvable object based on data associated with another object that may be related to the resolvable object. For example, a type may be associated with an alert based on metadata of an event that triggered the alert. For example, a classification may be associated with an incident based on metadata of an event that triggered an alert, which in turn triggered the incident.

In at least one of the various embodiments, a system for outlier detection using templates may include various components. In this example, the system 400 includes an ingestion engine 402, one or more partitions 404A-404B, one or more services 406A-406B and 408A-408B, a data store 410, a resolution tracker 412, a notification engine 414, and classifiers 418A-418B.

One or more systems, such as monitoring systems, of one or more organizations may be configured to transmit events to the system 400 for processing. The system 400 may provide several services. A service may, for example, process an event into another resolvable item (e.g., an incident). As mentioned above, a received event may trigger an alert, which may trigger an incident, which in turn may cause notifications to be transmitted to responders.

A received event from an organization may include an indication of one or more services that are to operate on (e.g., process, etc.) the event. The indication of the service is referred to herein as a routing key. A routing key may be unique to a managed organization. As such, two events that are received from two different managed organizations for processing by a same service would include two different routing keys. A routing key may be unique to the service that is to receive and process an event. As such, two events associated with two different routing keys and received from the same managed organization for processing may be directed to (e.g., processed by) different services.

The ingestion engine 402 may be configured to receive or obtain one or more different types of events provided by various sources, here represented by events 401A, 401B. The ingestion engine 402 may be configured to accept or reject received events. In an example, events may be rejected when events are received at a rate that is higher than a configured event-acceptance rate. If the ingestion engine 402 accepts an event, the ingestion engine 402 may place the event in a partition (such as one of the partitions 404A, 404B) for further processing. If an event is rejected, the event is not placed in a partition for further processing. The ingestion engine may notify the sender of the event of whether the event was accepted or rejected. Grouping events into partitions can be used to enable parallel processing and/or scaling of the system 400 so that the system 400 can handle (e.g., process, etc.) more and more events and/or more and more organizations (e.g., additional events from additional organizations).

The ingestion engine 402 may be arranged to receive the various events and perform various actions, including, filtering, reformatting, information extraction, data normalizing, or the like, or combination thereof, to enable the events to be stored (e.g., queued, etc.) and further processed. In at least one of the various embodiments, the ingestion engine 402 may be arranged to normalize incoming events into a unified common event format. Accordingly, in some embodiments, the ingestion engine 402 may be arranged to employ configuration information, including, rules, maps, dictionaries, or the like, or combination thereof, to normalize the fields and values of incoming events to the common event format. The ingestion engine 402 may assign (e.g., associate, etc.) an ingested timestamp with an accepted event.

In at least one of the various embodiments, an event may be stored in a partition, such as one of the partition 404A or the partition 404B. A partition can be, or can be thought of, as a queue (i.e., a first-in-first-out queue) of events. FIG. 4 is shown as including two partitions (i.e., the partitions 404A and 404B). However, the disclosure is not so limited and the system 400 can include one or more than two partitions.

In an example, different services of the system 400 may be configured to operate on events of the different partitions. In an example, the same services (e.g., identical logic) may be configured to operate on the accepted events in different partitions. To illustrate, in FIG. 4, the services 406A and 408A process the events of the partition 404A, and the services 406B and 408B process the events of partition the 404B, where the service 406A and the service 406B execute the same logic (e.g., perform the same operations) of a first service but on different physical or virtual servers; and the service 408A and the service 408B execute the same logic of a second service but on different physical or virtual servers. In an example, different types of events may be routed to different partitions. As such, each of the services 406A-406-B and 408A-408B may perform different logic as appropriate for the events processed by the service.

An (e.g., each) event, may also be associated with one or more services that may be responsible for processing the events. As such, an event can be said to be addressed or targeted to the one or more services that are to process the event. As mentioned above, an event can include or can be associated with a routing key that indicates the one or more services that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the system 400. Events as described above may be comprised of, or transmitted to the system 400 via, SMS messages, HTTP requests/posts, API calls, log file entries, trouble tickets, emails, or the like. An event may include associated information, such as, source, a creation time stamp, a status indicator, more information, fewer information, other information, or a combination thereof, that may be tracked.

In at least one of the various embodiments, a data store 410 may be arranged to store performance metrics, configuration information, or the like, for the system 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. For example, the data store 410 can include data related to resolved and unresolved alerts. For example, the data store 410 can include data identifying whether alerts are or are not acknowledged. For example, with respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto-resolved. That the alert is auto-resolved can mean that the system 400 received, such as from the integration, an event indicating that a previous event, which triggered the alert, is resolved. The integration may be a monitoring system.

The data store 410 can be used to store template data that can be used by a classifier (such as the classifier 418A or the classifier 418B) to obtain a type for a resolvable object. A classifier can use the template data to identify (e.g., select, choose, infer, determine, etc.) a template for the resolvable object. The data store 410 can be used to store an association between the resolvable object and the identified template. In an example, an identifier of the identified template can be stored as metadata of the resolvable object. As such, the data store 410 can include historical data of resolvable objects and corresponding templates.

In at least one of the various embodiments, the resolution tracker 412 may be arranged to monitor the details regarding how events, alerts, incidents, other objects received, created, managed by the system 400, or a combination thereof are resolved. In some embodiments, this may include tracking incident and/or alert life-cycle metrics related to the events (e.g., creation time, acknowledgement time(s), resolution time, processing time,), the resources that are/were responsible for resolving the events, the resources (e.g., the responder or the automated process) that resolved alerts, and so on. The resolution tracker 412 can receive data from the different services that process events, alerts, or incidents. Receiving data from a service by the resolution tracker 412 encompasses receiving data directly from the service and/or accessing (e.g., polling for, querying for, asynchronously being notified of, etc.) data generated (e.g., set, assigned, calculated by, stored, etc.) by the service. The resolution tracker can receive (e.g., query for, read, etc.) data from the data store 410. The resolution tracker can write (e.g., update, etc.) data in the data store 410. While FIG. 4 is shown as including one resolution tracker 412, the disclosure herein is not so limited and the system 400 can include more than one resolution tracker. In an example, different resolution trackers may be configured to receive data from services of one or more partitions. In an example, each partition may have associated with one resolution tracker. Other configurations or mappings between partitions, services, and resolution trackers are possible.

The notification engine 414 may be arranged to generate notification messages for at least some of the accepted events. The notification messages may be transmitted to responders (e.g., responsible users, teams) or automated systems. The notification engine 414 may select a messaging provider that may be used to deliver a notification message to the responsible resource. The notification engine 414 may determine which resource is responsible for handling the event message and may generate one or more notification messages and determine particular message providers to use to send the notification message.

In at least one of the various embodiments, a scheduler (not shown) may determine which responder is responsible for handling an incident based on at least an on-call schedule and/or the content of the incident. The notification engine 414 may generate one or more notification messages and determine a particular message providers to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to system 400 indicating a delivery status of the notification message (e.g., successful or failed delivery).

In at least one of the various embodiments, the notification engine 414 may determine the message provider based on a variety of considerations, such as, geography, reliability, quality-of-service, user/customer preference, type of notification message (e.g., SMS or Push Notification, or the like), cost of delivery, or the like, or combination thereof. In at least one of the various embodiments, various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured,

In at least one of the various embodiments, the system 400 may include various user-interfaces or configuration information (not shown) that enable organizations to establish how events should be resolved. Accordingly, an organization may define, rules, conditions, priority levels, notification rules, escalation rules, routing keys, or the like, or combination thereof, that may be associated with different types of events. For example, some events (e.g., of the frequent type) may be informational rather than associated with a critical failure. Accordingly, an organization may establish different rules or other handling mechanics for the different types of events. For example, in some embodiments, critical events (e.g., rare or novel events) may require immediate (e.g., within the target lag time) notification of a response user to resolve the underlying cause of the event. In other cases, the events may simply be recorded for future analysis.

In an example, one or more of the user interfaces may be used to associate runbooks with certain types of resolvable objects. A runbook can include a set of actions that can implement or encapsulate a standard operating procedure for responding to (e.g., remediating, etc.) events of certain types. Runbooks can reduce toil. Toil can be defined as the manual or semi-manual performance of repetitive tasks. Toil can reduce the productivity of responders (e.g., operations engineers, developers, quality assurance engineers, business analysts, project managers, and the like) and prevents them from performing other value-adding work. In an example, a runbook may be associated with a template. As such, if a resolvable object matches the template, then the tasks of the runbook can be performed (e.g., executed, orchestrated, etc.) according to the order, rules, and/or workflow specified in the runbook. In another example, the runbook can be associated with a type. As such, if a resolvable object is identified as being of a certain type, then the tasks of the runbook associated with the certain type can be performed. A runbook can be assembled from predefined actions, custom actions, other types of actions, or a combination thereof.

In an example, one or more of the user interfaces may be used by responders to obtain information regarding resolvable objects. For example, a responder can use one of the user interfaces to obtain information regarding incidents assigned to or acknowledged by the responder. The user interface can include classifications of the resolvable objects. For example, in a list display of resolvable objects, a column (or other types of user interface elements) can show respective types of at least some of the listed resolvable objects. In an example, a user interface (which may be referred to as a properties page) that displays information regarding details of a resolvable object can indicate (e.g., display) the type of the resolvable object. For example, a label (e.g., “rare,” “novel” or “frequent” or similar labels) may be displayed. In an example, a user interface can include an indication of the template identified for the resolvable object. In an example, a user interface control may be available to the responder (and other users) to view other resolvable objects associated with the same template.

In an example, the system 400 may display resolution information of at least some of the other resolvable objects associated with the same template. To illustrate, and without limitations, the system 400 may display resolution information (at least some of which may be entered by other responders) associated with a predefined number (e.g., 25, 50, or some other number) of most recently resolved other resolvable objects associated with the same template. The resolution information of the at least some of the other resolvable objects may be used to create runbooks. In an example, the resolution information may be matched (such as using natural language processing techniques) to details (e.g., descriptions, etc.) of the predefined actions, the custom actions, or the other types of actions to obtain a list of recommended actions that may be included in a runbook. To illustrate, and without limitations, the system 400 may display to a user the list of recommended actions and the reasons that the actions were recommended. The reasons for recommending an action can include indications of the subset of the resolution information that matched the details of the action. The user may select to include one or more of the recommended actions in the runbook. In some examples, only users with certain privileges or users that play certain roles (e.g., development and operations (DevOps) managers, senior technical managers, etc.) may be allowed to create and associate runbooks with templates.

At least one of the services 406A-406B and 408A-408B may be configured to trigger alerts. A service can trigger an incident from an alert, which in turn can cause notifications to be transmitted to one or more responders.

In the system 400, the classifiers 418A-418B are shown as classifying objects placed in the partitions 404A-404B, respectively. However, other arrangements (e.g., configurations, etc.) are possible. For example, alternatively or additionally, a classifier may be configured to asynchronously receive notifications when resolvable objects are created, such as, for example, when new resolvable objects are stored in the data store 410, when a service instantiates (e.g., creates, write to memory, etc.) a resolvable object, or the like.

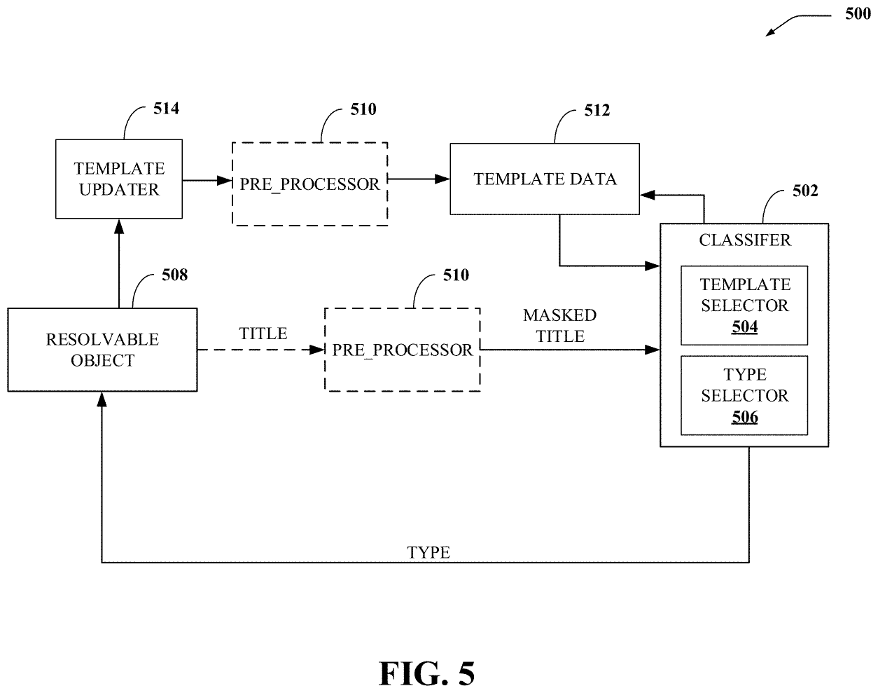

A classifier can receive resolvable objects in any number of other ways. A classifier may associate a template with a resolvable object and may associate a type with the resolvable object. In an example, a classifier may receive metadata (e.g., a title) of a resolvable object and return a template (e.g., an identifier of the template) to associate with the resolvable object and may return a type (i.e., a classification) to associate with the resolvable object. In some examples, a classifier may be configured to identify resolvable objects of certain types. If the classifier does not identify the resolvable object as being of (e.g., matching, etc.) one of the certain types, then the classifier may not associate a type with the resolvable object. A classifier 418 is further described with respect to FIG. 5.

In FIG. 4, a respective classifier is shown as being associated with each of the shown partitions. However, the disclosure is not so limited. For example, one or more than two classifiers can be available. For example, a respective classifier 418 can be available for, or associated with, one or more services, one or more routing keys, or one or more managed organizations. As such, for example, a classifier (e.g., templates therefor, as further described below) for a routing key can be constructed using historical resolvable objects where the historical resolvable objects correspond to or are triggered from the service of the routing key. In an example, different criteria can be used to obtain the historical data.

To illustrate further, and without limitations, whereas one classifier for one managed organization may be obtained using a first specified lookback time range (e.g., 30 days), another classifier for another managed organization may be obtained using a second specified lookback time range (e.g., 90 days). In an example, different classifiers may be configured with different rules (e.g., conditions, tests, evaluation criteria, etc.) for determining types. For example, whereas a first classifier may be configured to classify a resolvable object as frequent responsive to determining that the template associated with resolvable object occurred a predetermined number of times (e.g., 200 times) during a first lookback time range, a second classifier may be configured to classify a resolvable object as frequent responsive to determining that 20% of the historical data in a second lookback time range matched the template associated with the resolvable object.

FIG. 5 is a block diagram of an example 500 illustrating the operations of a classifier. The example 500 may be implemented in the system 400 of FIG. 4. The example 500 includes a classifier 502, which can be, can be included in, or can be implemented by, one of the classifiers 418A or 418B of FIG. 4. The classifier 502 includes a template selector 504 and a type selector 506.

The classifier 502 receives a masked title, which may be a masked title of a resolvable object 408, and outputs a type (e.g., a classification). The masked title can be obtained from (e.g., generated by, etc.) a pre-processor 510, which can receive the resolvable object 508 or the title of the resolvable title and outputs the masked title. The masked title can be associated with the resolvable object 508. In some examples, the title may not be pre-processed and the classifier 502 can classify the resolvable object 508 based on the title (instead of based on the masked title). In an example, the pre-processor 510 can be part of, or included in, the classifier 502. As such, the classifier 502 can receive the resolvable object 508 (of a title therefor), pre-process the title to obtain the masked title and then obtain a type based on the masked title.

Each resolvable object can have an associated title. The title of the resolvable object 508 may be or may be derived from another object that may be associated with or related to the resolvable object 508. As further described below, the classifier 502 uses historical data of observable objects to obtain (e.g., determine, choose, infer, identify, output, derive, etc.) a type for the resolvable object 508. While the description herein may use an attribute of a resolvable object that may be named “title” and refers to a “masked title,” the disclosure is not so limited. Broadly, a title can be any attribute, a combination of attributes, or the like that may be associated with a resolvable object and from which a corresponding masked string can be obtained.

For brevity, that the classifier 502 receives the resolvable object 508 encompasses at least one or a combination of the following scenarios. That the classifier 502 receives the resolvable object 508 can mean, in an implementation, that the classifier 502 receives the resolvable object 508 itself. That the classifier 502 receives the resolvable object 508 can mean, in an implementation, that the classifier 502 receives a masked title of the resolvable object. That the classifier 502 receives the resolvable object 508 can mean, in an implementation, that the classifier 502 receives the title of the resolvable object. That the classifier 502 receives the resolvable object 508 can mean, in an implementation, that the classifier 502 receives a title or a masked title of an object related to the resolvable object.

The pre-processor 510 may apply any number of text processing (e.g., manipulation) rules to the title of the resolvable object 508 to obtain the masked title. It is noted that the title is not itself changed as a result of the text processing rules. As such, stating that a rule X is applied to the title (such as the title of the resolvable object), or any such similar statements, should be understood to mean that the rule X is applied to a copy of the title. The text processing rules are intended to remove sub-strings that should be ignored when generating templates, which is further described below. For effective template generation (e.g., to obtain optimal templates from titles), it may be preferable to use readable strings (e.g., strings that include words) as inputs to the template generation algorithm. However, titles may not only include readable words. Titles may also include symbols, numbers, or letters. As such, before processing a title through any template generation or template identifying algorithm, the title can be masked to remove some substrings, such as symbols or numbers, to obtain an interpretable string (e.g., a string that is semantically meaningful to a human reader).

To illustrate, and without limitations, assume that a first title resolvable object has a first title “CRITICAL—ticket 310846 issued” and a second resolvable object has a second title “CRITICAL—ticket 310849 issued.” The first and the second titles do not match without further text processing. However, as further described herein, the first and the second titles may be normalized to the same masked title “CRITICAL—ticket <NUMBER> issued.” As such, for purposes of outlier detection using templates, the first resolvable object and the second resolvable object can be considered to be similar or equivalent.

A set of text processing rules may be applied to a title to obtain a masked title. In some implementations, more, fewer, other rules than those described herein, or a combination thereof may be applied. The rules may be applied in a predefined order.

A first rule may be used to replace numeric substrings, such as those that represent object identifiers, with a placeholder. For example, given the title “This is ticket 310846 from Technical Support,” the first rule can provide the masked title “This is ticket <NUMBER> from Technical Support,” where the numeric substring “310846” is replaced with the placeholder “<NUMBER>.” A second rule may be used to replace substrings identified as measurements with another placeholder. For example, given the title “Disk is 95% full in lt-usw2-dataspeedway on host:lt-usw2-dataspeedway-dskafka-03,” the second rule can provide the masked title “Disk is <MEASUREMENT> full in lt-usw2-dataspeedway on host:lt-usw2-dataspeedway-dskafka-03,” where the substring “95%” is replaced with the placeholder “<MEASUREMENT>”.

The text processing rules may be implemented in any number of ways. For example, each of the rules may be implemented as a respective set of computer executable instructions (e.g., a program, etc.) that carries out the function of the rule. At least some of the rules may be implemented using pattern matching and substitution, such as using regular expression matching and substitution. Other implementations are possible.

The classifier 502 uses a template data 512, which can include templates used for matching. The template selector 504 of the classifier 502 identifies a template of the template data 512 that matches the resolvable object 508 (or a title or a matched title, as the case may be, depending on the input to the classifier 502).

The type selector 506 obtains a classification (i.e., a type) for the resolvable object based on the identified template. The type selector 506 uses historical data and the identified template to obtain the type. As mentioned above, the type selector 506 can obtain the type according to one or more configurations. As such, for example, responsive to historical data meeting a first condition, the type selector can determine (e.g., identify, select, choose, obtain, etc.) that the resolvable object 508 is of the rare type; responsive to the historical data meeting a second condition, the type selector can determine that the resolvable object 508 is of the novel type; and responsive to the historical data meeting a third condition, the type selector can determine that the resolvable object 508 is of the frequent type.

To illustrate, and without limitations, if a template matching the title of an incident occurs more than 20% of the times in the last 30 days of the historical incident data of a service, then the incident is classified as being of the frequent type. Said another way, if at least 20% of titles of the last 30 days of incidents match the same template, then any incidents matching the template are classified as frequent incidents. As another illustration, if a template identified for an incident occurs less than 5% but more than 0% in the last 30 days in the historical incident data of a service, then the incident is of the rare type. In yet another illustration, if the template associated with an incident has not occurred in the last 30 days, then the incident is classified as novel (or as an anomaly).

A template updater 514 can be used to update the template data 512. The template data 512 can be updated according to update criteria. In an example, resolvable objects received within a recent time window can be used to update the template data 512. In an example, the recent time window can be 10 seconds, 15 seconds, 1 minute, or some other recent time window. In an example, the template data 512 is updated after at least a certain number of new resolvable objects are created in the system 400 of FIG. 4. Other update criteria are possible. For example, the template data of different routing keys or of different managed organizations can be updated according to different update criteria.

In an example, the template updater 514 can be part of the template selector 504. As such, in the process of identifying templates for resolvable objects received within the recent time window, new templates may be added to the template data 512. Said another way, in the process of identifying a type of a resolvable object (based on the title or the masked title, as the case may be), if a matching template is identified, that template is used; otherwise, a new template may be added to the template data 512.

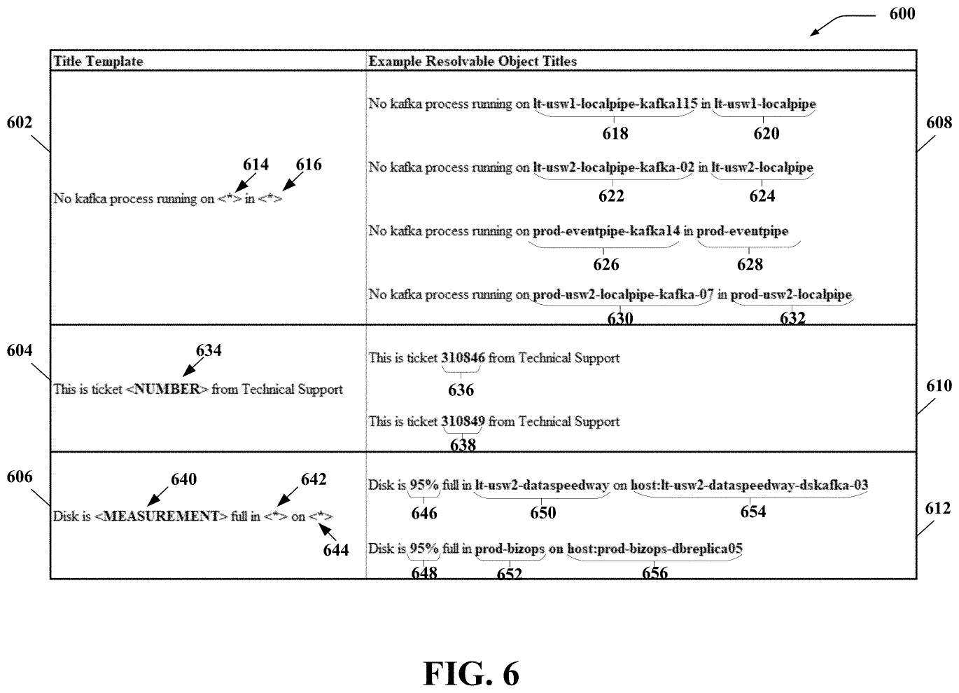

FIG. 6 illustrates examples 600 of templates. Templates can be obtained from titles or masked titles, as the case may be. FIG. 6 illustrates three templates; namely templates 602-606. The templates 602, 604, 606 may be derived from (i.e., at template update time) or may match (i.e., at classification time) the title groups 608, 610, 612, respectively.

As mentioned above, templates include constant parts and variable parts. The constant parts of a template can be thought of as defining or describing, collectively, a distinct state, condition, operation, failure, or some other distinct semantic meaning as compared to the constant parts of other templates. The variable parts can be thought of as defining or capturing a dynamic, or variable state to which the constant parts apply.

To illustrate, the template 602 includes, in order of appearance in the template, the constant parts “No,” “kafka,” “process,” “running,” and “in;” and includes variable parts 614 and 616 (represented by the pattern <*> to indicate substitution patterns). The variable part 614 can match or can be derived from substrings 618, 622, 626, and 630 of the title group 608; and the variable part 616 can match or can be derived from substrings 620, 624, 628, and 632 of the title group 608. The template 604 does not include variable parts. However, the template 604 includes a placeholder 634, which is identified from or matches a mask of numeric substrings 636 and 638, as described above. The template 606 includes a placeholder 640 and variable parts 642, 644. The placeholder 640 can result from or match masked portions 646 and 648. The variable part 642 can match or can be derived from substrings 650 and 652. The variable part 644 can match or can be derived from substrings 654 and 656.

In obtaining templates from titles or masked titles, as the case may be, such as by the template updater 514, it is desirable that the templates include a balance of constant and variable parts. If a template includes too many constant parts as compared to the variable parts, then the template may be too specific and would not be usable to combine similar titles together into a group or cluster for the purpose of classification. Such a template can result in false negatives (i.e., unmatched titles that should in fact be identified as similar to other titles). If a template includes too many variable parts as compared to the constant parts, then the template can practically match titles even though they are not in fact similar. Such templates can result in many false positive matches.

To illustrate, given the title “vednssoa04.atlqa1/keepalive:No keepalive sent from client for 2374 seconds (>=120),” a first algorithm may obtain a first template “vednssoa04.atlis1/keepalive:No keepalive sent from client for <*> seconds <*>,” a second algorithm may obtain a second template “<*>:<*> <*> <*> <*> client <*> <*> <*> <*>,” and a third algorithm may obtain a third template “<*>:No keepalive sent from client for <*> seconds <*>.” The first template capturers (includes) very few parameters as compared to the constant parts. The second template includes too many parameters. The third template includes a balance of constant and variable parts.

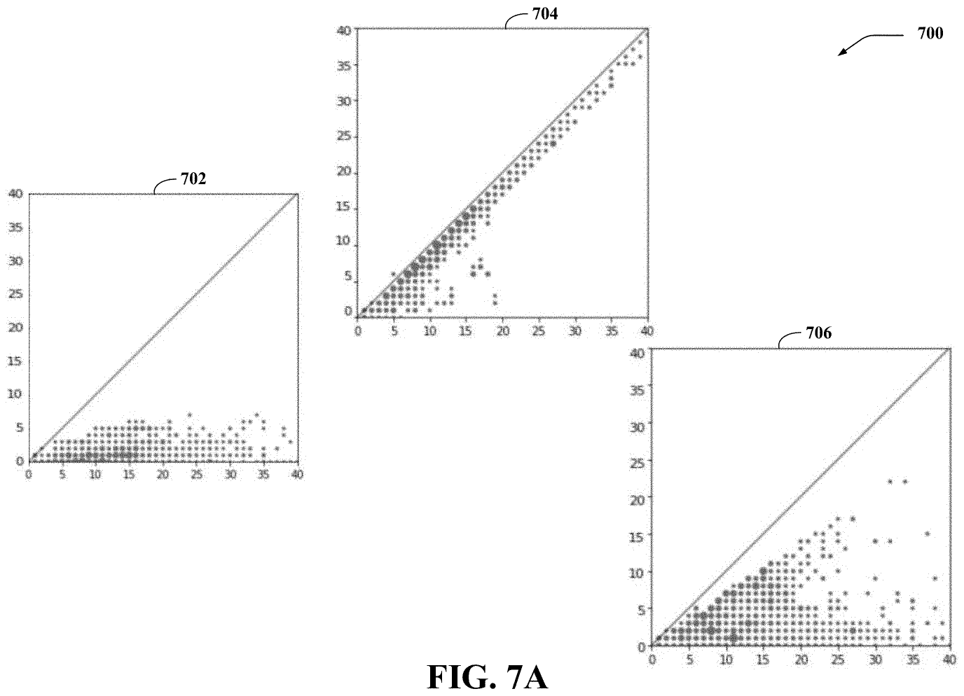

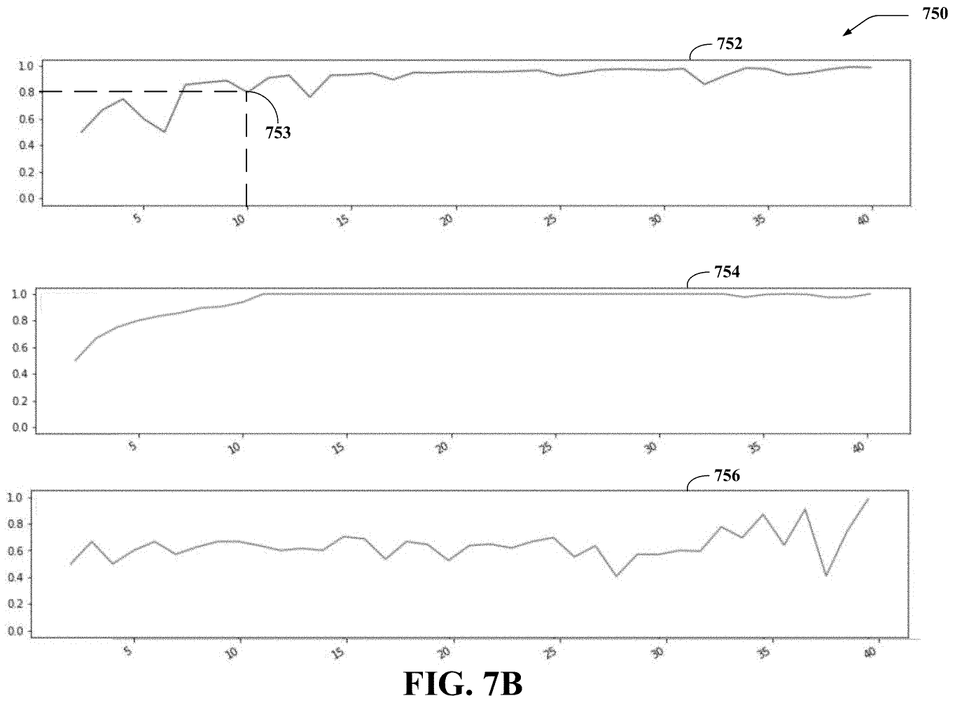

FIG. 7A illustrates plots 700 of results of algorithms that generate optimal and sub-optimal templates. The plots 700 includes a first scatter plot 702 corresponding to the first algorithm mentioned above, a second scatter plot 704 corresponding to the second algorithm mentioned above, and a third scatter plot 706 corresponding to the third algorithm mentioned above. The scatter plots of FIG. 7 plot the number of tokens (i.e., the x-axis) in titles against the number of parameters (i.e., the variable parts) in the corresponding templates on the y-axis obtained using the algorithm corresponding to the plot. For example, the title “No kafka process running on It-usw1-localpipe-kafka115 in It-usw1-localpipe” includes 8 tokens and the corresponding title “No kafka process running on <*> in <*>” includes 2 parameters.

As already eluded to, algorithms that result in too many points close to the x-axis or close to the diagonal line are undesirable. A scatter plot (such as the first scatter plot 702) that includes too many points close to the x-axis can mean that there are not many parameters in the obtained templates. A scatter plot (such as the second scatter plot 704) that includes too many points close to the diagonal line can mean that almost all tokens of titles are mapped to parameters. Contrastingly, and desirably, the scatter plot 706 does not exhibit either of the preceding conditions. As such, the templates obtained using the third algorithm can be considered to be better templates than the templates obtained using the first and the second algorithms. Templates may be expected to include more constant parts than variable parts. As such, it can be expected that most points may be below the diagonal line. It is noted that the size of a point in the scatter plots of FIG. 7 is an indicator for the number of the titles that have the same number of tokens and parameters.

FIG. 7B illustrates graphs 750 of template similarities of algorithms that generate optimal and sub-optimal templates. It is desirable that templates obtained using a template-obtaining algorithm (such as the first, second, and third, algorithms described with respect to FIG. 7A) be sufficiently different. For example, templates having the same length should be sufficiently different. That is, the similarity distribution between templates (e.g., templates of the same length) should not skew towards 1.0 (the maximum similarity possible).

The graphs 750 plot the 99^{th} percentile of similarity of obtained templates using the algorithms described above at every message length that contains more than one template. The 99^{th} percentile is used since if the similarity is not saturated at this point, then the algorithm is considered to produce optimal templates (or at least better templates than the alternative algorithms). Graphs 752, 754, 756 plot the 99^{th} percentile of similarity of templates obtained using the first algorithm (corresponding to the first scatter plot 702), the second algorithm (corresponding to the second scatter plot 704), and the third algorithm (corresponding to the third scatter plot 706), respectively.

The x-axes represent the template lengths (e.g., in number of tokens) and the y-axes represent the similarity indexes. For example, a point 753 of the graph 752 indicates that the templates having 10 tokens are calculated to have a similarity index of 0.8. Several techniques can be used to calculate the similarity index. In an example, the Jaccard Index can be used. In another example, which is used to obtain the graphs 750, each template can be vectorized and the cosine similarity for the vectorized templates at each length can be calculated.

The graph 752 illustrates that the similarity tends to 1.0 for most template lengths. As such, the first algorithm is not an optimal algorithm for obtaining templates. The graph 754 illustrates that the similarity tends to 1.0 for most template lengths, even more so than in the graph 752. As such, the second algorithm is also not an optimal algorithm for obtaining templates. The graph 756 illustrates that the similarity is fairly consistent and hover around the 60% mark at most lengths, with a few outliers. As such, the third algorithm is a better algorithm for generating templates than the first and the second algorithms.

Returning again to FIG. 5, the template selector 504 can be implemented in any number of ways. In an example, a log-parsing technique or algorithm can be used to obtain templates from resolvable objects. In an implementation, the technique or algorithm used can be an off-line technique or algorithm in which obtaining templates to match against and matching titles to templates are separate steps (e.g., separated in time) where obtaining additional templates can be a batch off-line process. In an implementation, the technique or algorithm used can be an on-line technique or algorithm in which an initial set of templates may be obtained using a batch process and new templates are obtained from titles received for matching in real-time or in near real-time.

As described with respect to FIG. 5, in the case of an off-line processor (parser) the template updater 514 may be separate from the template selector 504; and in the case of an on-line processor (parser), the template updater 514 may be part or, combined with, or works in conjunction with the template selector 504. As such, responsive to new resolvable data (i.e., titles or masked titles therefor) received at the classifier 502 or the template selector 504 therein of FIG. 5, the template data 512 can be recalculated (e.g., regenerated, updated, etc.) by (e.g., according to, to incorporate, etc.) any new resolvable data. As such, the template selector 504 not only applies existing templates of the template data 512 for matching, the template selector 504 can also update the template data 512 to include new templates, which may be influenced by the resolvable data (or a subset thereof).

In an example, obtaining the template may be delayed (e.g., deferred) for a short period of time until the template data 512 is updated based on most recently received resolvable objects according to an update criterion. The update criterion can be time based (i.e., a time-based criterion), count based (i.e., a count-based criterion), other update criterion, or a combination thereof. In example, the update criterion may be or may include updating the template data 512 at a certain time frequency (e.g., every 15 seconds or some other frequency). In example, the update criterion may be or may include updating the template data 512 after a certain number of new resolvable objects are received (e.g., every 100, 200, more or fewer new resolvable objects are received). In an example, if the count-based criterion is not met within a threshold time, then the template data 512 is updated according the new resolvable objects received up to the expiry of the threshold time. To illustrate, and without limitations, assume that the update criterion is set to be or equivalent to “every 75 new objects” and that a new resolvable object is the 56^{th} object received in the update window. A template is not obtained for the this resolvable object until after the 75^{th} resolvable object is received and the template data 512 is updated using the 75 new objects.

Examples of techniques or algorithms that may be used include, but are not limited to using well known techniques such as regular expression parsing, Streaming structured Parser for Event Logs using Longest common subsequence (SPELL), Simple Logfile Clustering Tool (SLECT), Iterative Partitioning Log Mining (IPLoM), Log File Abstraction (LFA), Depth tRee bAsed onlIne log parsiNg (DRAIN), or other similar techniques or algorithms. At least some of these algorithms or techniques are machine learning techniques that use unsupervised learning to learn (e.g., incorporate) new templates in their respective models based on new received data. In an example, DRAIN may be used. A detailed description of DRAIN or any of the other algorithms is not necessary as a person skilled in the art is, or can easily become, familiar with log parsing techniques, including DRAIN, which is a machine learning model that uses unsupervised learning. However a general overview of DRAIN is now provided.

DRAIN organizes templates into a parse tree with a fixed depth. Each first level node (i.e., each node in the first layer of the parse tree) corresponds to a template length and all leaf nodes can have the same depth. The depth of the parse tree can be set as a configuration. DRAIN organizes the resolvable objects into clusters (or groups) where each group is represented by a template. As such, each cluster can include multiple resolvable objects that match the template of the cluster. Each leaf node can include multiple templates.

To identify a template matching a received resolvable object (or title or masked title), DRAIN traverses the parse tree by following the branch that corresponds to the length of the resolvable object (i.e., the title or the masked title, as the case may be). DRAIN selects a next internal node by matching a token in a current position of a title to a current internal node of the parse tree. When a lead node is reached, DRAIN calculates a similarity between each template at the leaf node and the resolvable object to be matched according to formula (1). In formula (1), seq₁ and seq₂ represent the title (or masked title) of the resolvable object and a template, respectively; seq(i) represents an i^{th} token; n is the template length; t₁ and t₂ are two tokens, and equ( ) is a function that accepts two tokens as inputs and output a 1 if the input tokens are equal and a 0 if the inputs tokens are not equal.

$$simSeq = {\sum }_{i = 1}^{n} equ ( {seq}_{1} ( i ) , {seq}_{2} ( i ) ) / n \qquad ( 1 )$$

$$equ ( {t}_{1} , {t}_{2} ) = \{ \begin{matrix}1 if {t}_{1} = {t}_{2} \\ 0 otherwise\end{matrix}$$

DRAIN selects the most suitable template from amongst the templates at the leaf node. The most suitable template is the template with the largest calculated simSeq value. If the maximum simSeq is greater than a threshold, then the template is selected (e.g., identified, etc.) for the resolvable object. The threshold can be 60% or some other threshold value. If no suitable template is identified, a new cluster (i.e., a new template) is created based on the current resolvable object.

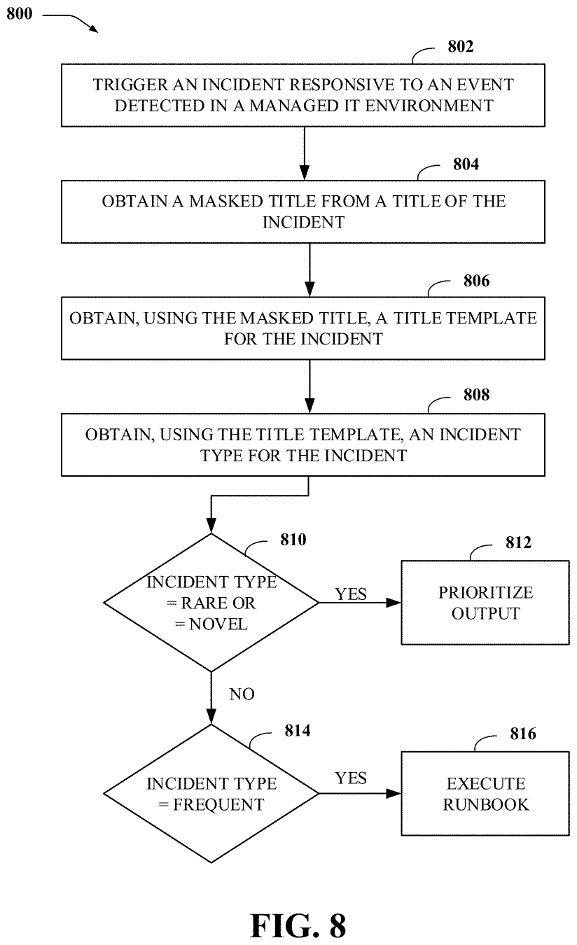

FIG. 8 is a flowchart of an example of a technique 800 for incident type detection using templates. The technique 800 can be implemented in or by an EMB, such as the system 400 of FIG. 4. The technique 800 may be implemented in whole or in part in or by the ingestion engine 402, one or more of the services 406A-406B and 408A-408B, or a classifier, such as one of the classifiers 418A-418B of the system 400 of FIG. 4. The technique 800 can be implemented, for example, as a software program that may be executed by computing devices such as the network computer 300 of FIG. 3. The software program can include machine-readable instructions that may be stored in a memory (e.g., a non-transitory computer readable medium), such as the memory 304, the processor-readable stationary storage device 334, or the processor-readable removable storage device 336 of FIG. 3, and that, when executed by a processor, such as the processor 302 of FIG. 3, may cause the computing device to perform the technique 800. The technique 800 can be implemented using specialized hardware or firmware. Multiple processors, memories, or both, may be used.

At 802, the technique 800 triggers an incident that requires a resolution responsive to an event detected in a managed information technology environment. In an example, and as described with respect to FIG. 4, an event may be received from a monitoring tool that monitors at least some aspects (e.g., components, devices, applications, services, etc.) of the information technology environment. In an example, the event may trigger an alert, which may in turn trigger the incident. In an example, and as

At 804, the technique 800 obtains a masked title from a title of the incident. The masked title can be obtained as described with respect to the pre-processor 510 of FIG. 5. As such, obtaining the masked title from the title of the incident can include replacing an identifier in the title of the incident with a first representative token; and replacing a numeric sub-string of the incident with a second predefined token.

At 806, the technique 800 obtains, using the masked title, a title template for the incident. The title template can be obtained as described with respect to template selector 504 of FIG. 5. As such, the title template can be obtained using a machine learning model that uses unsupervised learning and that receives the masked title as input and outputs the title template. Outputting the title template can mean, or encompass, outputting an indication (e.g., an identifier) of the title template. The title template (or the identifier of the title template) can be associated with the incident. The machine learning model includes a set of title templates to select from. When a new title is received and for which no template can be matched, the machine learning model obtains a new title template from the title and incorporates the new title template in the set of title templates. In an example, the machine learning model can be, or can be based on, DRAIN.

In an example, obtaining the title template may be delayed (e.g., deferred) for a short period of time (e.g., 15 seconds, 30 seconds, or some other period of time) until the machine learning model is updated based on most recently received incidents, as described above. As such, the technique 800 retrains, in real-time and before obtaining the incident type for the incident, the machine learning model using incidents received in an immediately preceding time window. Retraining, in the real-time, the machine learning model can include obtaining templates from incident data where the templates include constant parts and parameter parts and the obtained templates are such that a first cardinality of the constant parts in the templates is not skewed as compared to a second cardinality of the parameter parts, as described above.

At 808, the technique 800 obtains, using the title template, an incident type for the incident. The incident type can be obtained as described with respect to the classifier 502 of FIG. 5. More specifically, the title template can be used by the type selector 506 to obtain the incident type. The type selector can determine the incident type based on a number of occurrences of the title template in a historical incident data. In an example, the historical incident data can be time based (all incidents received in the last 30 days). In an example, the historical incident data can be count based (the last predetermined number of incidents received).

At 810, the technique 800 determines whether the incident of the type rare or novel. If so, the technique 800 proceeds to 812; otherwise the technique 800 proceeds to 814 to determine whether the incident is of the type frequent. If the incident is of the frequent type, the technique 800 proceeds to 816. Determining the incident type can be as described above. As such, the technique 800 can include, responsive to incident data meeting a first condition, determining that the incident is of the rare type; responsive to the incident data meeting a second condition, determining that the incident is of the novel type; and responsive to the incident data meeting a third condition, determining that the incident is of the frequent type.

At 812, the technique 800 prioritizes an output of the incident so as to focus an attention of a responder on the incident. For example, in a display list of incidents to a responder, the list may be sorted to include the rare and novel incidents above frequent or unclassified incidents. In an example, the type of incident may be prominently displayed on a properties page of the incident. At 816, the technique 800 executes a runbook of tasks associated with the title template of the incident.

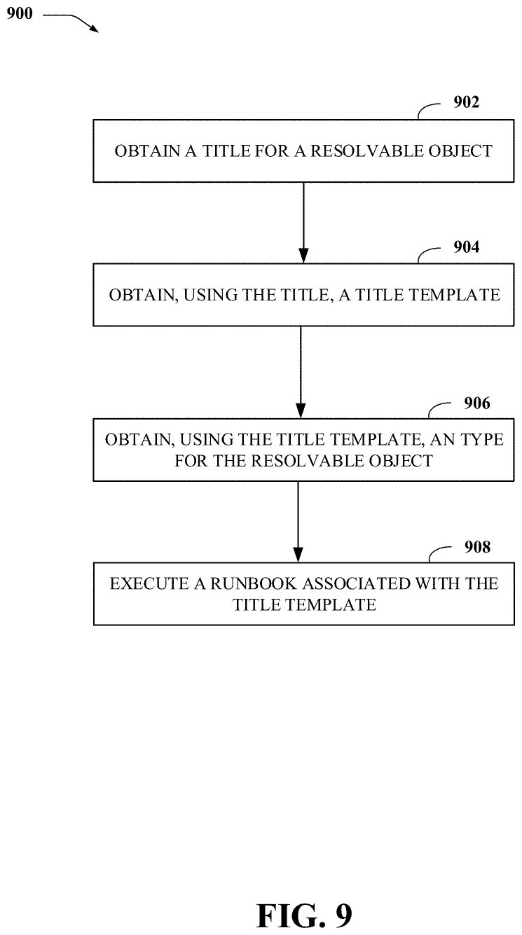

FIG. 9 is a flowchart of an example of a technique 900 for resolvable object type detection using templates. The technique 900 can be implemented in or by an EMB, such as the system 400 of FIG. 4. The technique 900 may be implemented in whole or in part in or by the ingestion engine 402, one or more of the services 406A-406B and 408A-408B, or a classifier, such as one of the classifiers 418A-418B of the system 400 of FIG. 4. The technique 900 can be implemented, for example, as a software program that may be executed by computing devices such as the network computer 300 of FIG. 3. The software program can include machine-readable instructions that may be stored in a memory (e.g., a non-transitory computer readable medium), such as the memory 304, the processor-readable stationary storage device 334, or the processor-readable removable storage device 336 of FIG. 3, and that, when executed by a processor, such as the processor 302 of FIG. 3, may cause the computing device to perform the technique 900. The technique 900 can be implemented using specialized hardware or firmware. Multiple processors, memories, or both, may be used.

At 902, the technique 900 obtains a title for a resolvable object. Obtaining the title can include obtaining a masked title by performing text processing tasks on the title to obtain the masked title. Performing the text processing tasks can include replacing an identifier in the title with a first representative token and replace a numeric sub-string of the title with a second predefined token.

At 904, the technique 900 obtains, using the title, a title template for the resolvable object. The title template can be obtained using a machine learning model that uses unsupervised learning and that receives the title as input and outputs the title template. In an example, the technique 900 can retrain, in real-time and before obtaining the type for the resolvable object, the machine learning model using resolvable objects received according to an update criterion. In an example, the update criterion can be a time-based criterion. In an example, the update criterion can be a count-based criterion. Retraining, in the real-time, the machine learning model can include obtaining templates from resolvable object data according to the update criterion, where the templates are such that a first cardinality of constant parts in the templates is not skewed as compared to a second cardinality of parameter parts.

At 906, the technique 900 obtains, using the title template, a type for the resolvable object. The type can be selected from a set comprising a rare type and a frequent type. Obtain using the title template, the type for the resolvable object can include responsive to resolvable object history data (i.e., historical resolvable object data) meeting a first condition, determine that the resolvable object is of the rare type; and responsive to the resolvable object history data meeting a second condition, determine that the resolvable object is of the frequent type.

At 908, the technique 900 executes a runbook associated with the title template responsive to determining that the resolvable object is of the frequent type. In an example, responsive to determining that the resolvable object is of the rare type, the technique 900 prioritizes an output of the resolvable object.

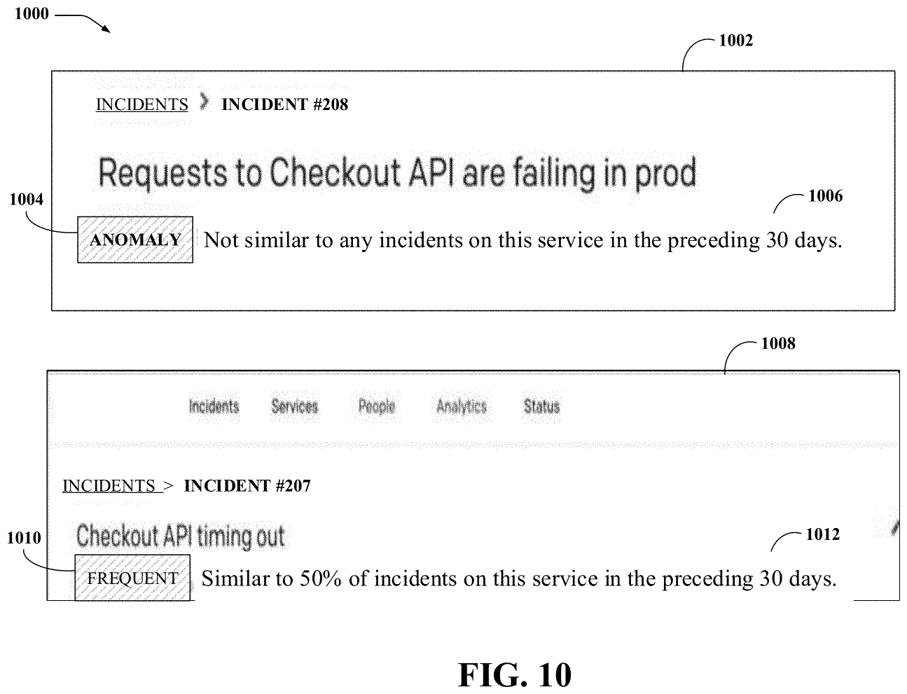

FIG. 10 illustrates examples 1000 of partial displays of resolvable objects. A first example 1002 illustrates a partial display of a resolvable object that is an incident object. The first example 1002 includes a type 1004 with the label “ANOMALY” (i.e., the novel type) indicating that, this incident, as indicated by a description 1006, is “Not similar to any incidents . . . in the preceding 30 days.” A second example 1008 illustrates a partial display of a second resolvable object that is also an incident object. The second example 1008 includes a type 1010 with the label “FREQUENT” (i.e., the frequent type) indicating that, this incident, as indicated by a description 1006, is “Similar to 50% of incidents . . . in the preceding 30 days.”

For simplicity of explanation, the techniques 800 and 900 of FIGS. 8 and 9, respectively, are each depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C#, and/or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage devices and be stored on and executed by one or more general purpose computers, thus creating a special purpose computer configured to provide the engine.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
triggering an incident that requires a resolution responsive to an event detected in a managed information technology environment;
obtaining a masked title from a title of the incident;
obtaining, using the masked title, a title template for the incident;
obtaining, using the title template, an incident type for the incident, wherein the incident type is selected from a set comprising a rare type, a novel type, and a frequent type;
responsive to determining that the incident is of the rare type or the novel type, prioritizing an output of the incident so as to focus an attention of a responder on the incident; and
responsive to determining that the incident is of the frequent type, automatically executing a runbook of tasks associated with the title template.

2. The method of claim 1, wherein obtaining the masked title from the title of the incident comprises:
replacing an identifier in the title of the incident with a first representative token; and
replacing a numeric sub-string in the title of the incident with a second predefined token.

3. The method of claim 1, wherein the title template is obtained using a machine learning model that uses unsupervised learning and that receives the masked title as input and outputs the title template.

4. The method of claim 3, further comprising:
retraining, in real-time and before obtaining the incident type for the incident, the machine learning model using incidents received in an immediately preceding time window.

5. The method of claim 4, wherein retraining, in the real-time, the machine learning model comprises:
obtaining templates from incident data,
wherein the templates comprise constant parts and parameter parts, and
wherein the templates are such that a first cardinality of the constant parts in the templates is not skewed as compared to a second cardinality of the parameter parts.

6. The method of claim 1, wherein obtaining, using the title template, the incident type for the incident comprises:
responsive to incident data meeting a first condition, determining that the incident is of the rare type;
responsive to the incident data meeting a second condition, determining that the incident is of the novel type; and
responsive to the incident data meeting a third condition, determining that the incident is of the frequent type.

7. An apparatus, comprising:
a memory; and
a processor, the processor configured to execute instructions stored in the memory to:
obtain a title for a resolvable object;
obtain, using the title, a title template for the resolvable object;
obtain, using the title template, a type for the resolvable object, wherein the type is selected from a set comprising a rare type and a frequent type; and
responsive to determining that the resolvable object is of the frequent type, execute a runbook associated with the frequent type.

8. The apparatus of claim 7, wherein the processor is further configured to:
responsive to determining that the resolvable object is of the rare type, prioritize an output of the resolvable object.

9. The apparatus of claim 7, wherein to obtain the title comprises to obtain a masked title by performing text processing tasks on the title to obtain the masked title.

10. The apparatus of claim 9, wherein to perform the text processing tasks on the title to obtain the masked title comprises to:
replace an identifier in the title with a first representative token; and
replace a numeric sub-string of the title with a second predefined token.

11. The apparatus of claim 7, wherein the title template is obtained using a machine learning model that uses unsupervised learning and that receives the title as input and outputs the title template.

12. The apparatus of claim 11, wherein the processor is further configured to:
retrain, in real-time and before obtaining the type for the resolvable object, the machine learning model using resolvable objects received according to an update criterion.

13. The apparatus of claim 12, wherein the update criterion is a time-based criterion.

14. The apparatus of claim 12, wherein the update criterion is a count-based criterion.

15. The apparatus of claim 12, wherein to retrain, in the real-time, the machine learning model comprises to:
obtain templates from resolvable object data according to the update criterion, wherein the templates are such that a first cardinality of constant parts in the templates is not skewed as compared to a second cardinality of parameter parts.

16. The apparatus of claim 7, wherein to obtain, using the title template, the type for the resolvable object comprises to:
responsive to resolvable object history data meeting a first condition, determine that the resolvable object is of the rare type; and
responsive to the resolvable object history data meeting a second condition, determine that the resolvable object is of the frequent type.

17. A method, comprises:
identifying, in a set of templates, a template matching a title of a resolvable object, wherein at least some of the templates comprise respective constant parts and respective parameter parts;
obtaining a type of the resolvable object using the template and historical resolvable object data; and
outputting the type in association with the resolvable object.

18. The method of claim 17, wherein the historical resolvable object data is obtained using an update criterion.

19. The method of claim 18, wherein the update criterion is a time-based criterion.

20. The method of claim 18, wherein the update criterion is a count-based criterion.
